(19) United States
(12) Patent Application Publication
(10) Pub. No.: US 2008/0117188 A1
(43) Pub. Date: May 22, 2008

(54) ELECTRONIC DEVICES HAVING A TOUCH SCREEN AND METHOD FOR STARTING THE ELECTRONIC DEVICES

(75) Inventors: CHUNG-YANG KO, Tu-Cheng (TW); CHIN-FENG CHEN, Tu-Cheng (TW); TAY-YANG LIN, Tu-Cheng (TW); YUAN-HUNG CHIEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/843,658

(22) Filed: Aug. 23, 2007

(30) Foreign Application Priority Data
Nov. 20, 2006 (CN) 200610201105.9

(51) Int. Cl. G06F 3/041

(52) U.S. Cl. 345/177

(57) ABSTRACT

An exemplary electronic device (10) comprises a display (11), a chip controller (131), a power supply (14) and a main processor (12). The display has a surface acoustic touch screen (111). The touch screen comprises a substrate (113), two transmitting transducers (114), two receiving transducers (115), two first reflection strips (116), and two second reflection strips (117). The transmitting transducers and the receiving transducers are disposed on the substrate. The power supply is electrically connected to and controlled by the chip controller. The main processor is electrically connected to the transmitting transducers, the receiving transducers, and the chip controller. The main processor is used to contain a start operational input and calculate a touched signal that the touch screen touched. The main processor further compares the touched signal with the start operational input to decide whether to send a start instruction the chip controller to start the electronic device.

### CROSS-REFERENCE TO RELATED APPLICATIONS

This application is related to four co-pending U.S. patent applications (Attorney Docket No. US11802, US11803, US11804, US11805), all entitled “ELECTRONIC DEVICES HAVING A TOUCH SCREEN AND METHOD FOR STARTING THE ELECTRONIC DEVICES”, by Chung-Yang Ko et al. Such applications have the same assignee as the instant application and are concurrently filed herewith. The disclosure of the above-identified applications is incorporated herein by reference.

### BACKGROUND OF THE INVENTION

1. Field of the Invention

The present invention relates to electronic devices having a touch screen and methods for starting the electronic devices.

2. Discussion of the Related Art

Nowadays, electronic devices are popular and are used in a variety of situations. However, electronic devices also carry certain risks. For example, personal information stored in electronic devices such as mobile phones, personal digital assistants (PDAs) and personal computers may be stolen by others.

One typical electronic device includes an on/off key and a lock/unlock key. Anyone can turn on or unlock the electronic device by pressing the on/off key or the lock/unlock key when the electronic device is turned off or locked. Thus, information stored in the electronic device can be easily accessed and used for malicious purposes. In order to keep information secured, passwords are usually required when turning on or unlocking the electronic device. However, inputting passwords often involves typing several letters and/or numbers on a keyboard, making it very inconvenient to turn on or unlock the electronic device.

Therefore, a need exist for electronic devices that can conveniently be turned on or unlock, to keep information secured, and the methods thereof.

### SUMMARY

An exemplary electronic device includes a display, a chip controller, a power supply and a main processor. The display has a surface acoustic touch screen. The touch screen comprises a substrate, two transmitting transducers, two receiving transducers, two first reflection strips respectively facing one of the transmitting transducers and one of the receiving transducers, and two second reflection strips respectively facing the other sending transducer and the other receiving transducer. The transmitting transducers and the receiving transducers are disposed on the substrate. The power supply is electrically connected to and controlled by the chip controller. The main processor is electrically connected to the transmitting transducers, the receiving transducers, and the chip controller. The main processor is used to contain a start operational input including at least one of a predetermined touched area, a predetermined touched duration, a predetermined number of touched times and a predetermined touched pressure and calculate a touched signal including at least one of a touched position, a touched duration, a number of touched times and a touched pressure that the touch screen touched according to signals sent from the receiving transducers. The main processor is used to further compare the touched signal with the start operational input to decide whether to send a start instruction the chip controller to start the electronic device.

Other advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present electronic device and associated electronic device. Moreover, in the drawings, like reference numerals designate corresponding parts throughout the several views, and all the views are schematic.

FIG. 1 is an exploded, isometric view of an electronic device in accordance with an exemplary embodiment of the present invention.

FIG. 2 is a schematic view of sound wave transmission when a touch screen of the electronic device of FIG. 1 is touched.

FIG. 3 is a top plan view of the touch screen of FIG. 2 divided by imaginary lines.

FIG. 4 is a flow chart of starting the electronic device of FIG. 1.

### DETAILED DESCRIPTION OF THE EMBODIMENTS

The present invention provides an electronic device such as a mobile phone or a PDA, and a method for starting the electronic device.

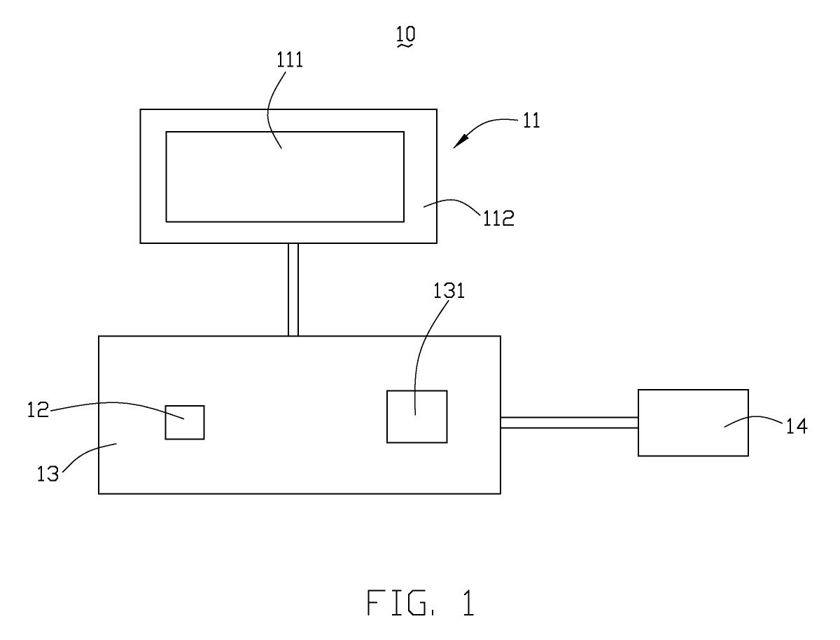

Referring to FIG. 1, an electronic device 10 includes a display 11, a main processor 12, a circuit board 13, and a power supply 14. The display 11 includes a touch screen 111 and a frame 112 confining the touch screen 111. A chip controller 131 is mounted on the circuit board 13. The main processor 12 is mounted on the circuit board 13. The display 11 is electrically connected to the main processor 12 via the circuit board 13, and the power supply 14 is electrically connected to the chip controller 131 via the circuit board 13. The chip controller 131 is electrically connected to the main processor 12 via the circuit board 13. Alternatively, the main processor 12 can also be outside the circuit board 13 and directly connected to the display 11 and the power supply 14.

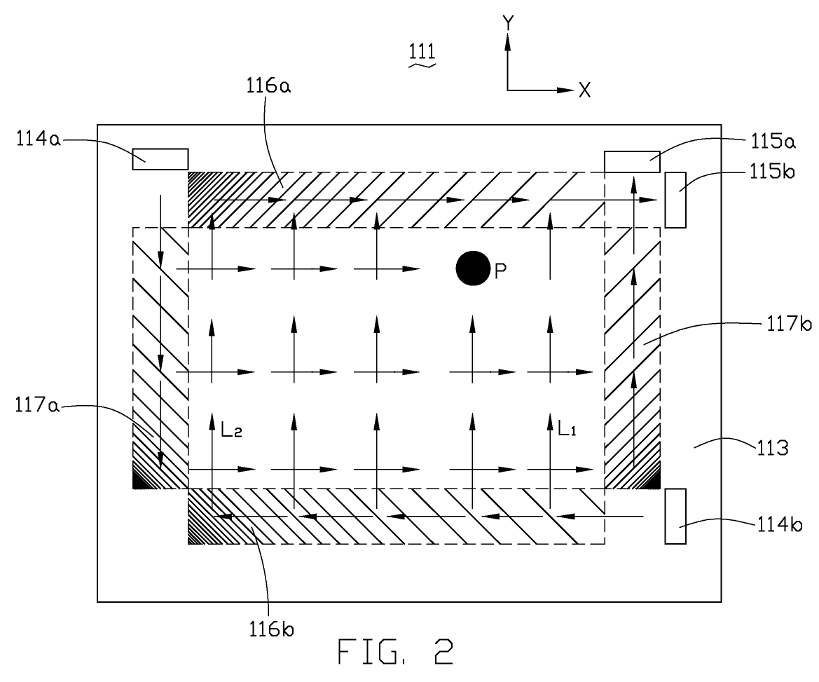

Also referring to FIG. 2, the touch screen 111 is an acoustic touch screen which includes a substrate 113, two transmitting transducers 114a, 114b, two receiving transducers 115a, 115b, two first reflection strips 116a, 116b, and two second reflection strips 117a, 117b. In an illustrated embodiment, the substrate 113 is a rectangular shaped glass sheet. The first reflection strips 116a, 116b are each correspondingly mounted at two opposite edges of the substrate 113, and the second strips 117a, 117b are each correspondingly mounted at the other two edges of the substrate 113. The transmitting transducers 114a, 114b are correspondingly mounted at corners diagonally across the substrate 113, with the sending transducer 114a facing the second reflection strip 117a and the sending transducer 114b facing the first reflection strip 116b. The receiving transducers 115a, 115b are mounted at other corners diagonally across the substrate 113, with the receiving transducer 115a facing the second reflection strip 117b and the receiving transducer 115b facing the first reflection strip 116a. The transmitting transducers 114a, 114b and the receiving transducers 115a, 115b are electrically connected to the main processor 12 respectively.

How the touch screen 111 works is described herein. The sending transducer 114b receives and converts electrical signals sent by the main processor 12 into bulk acoustic waves. The bulk acoustic waves are transmitted along an X-direction parallel to the first reflection strips 116a, 116b. Then the first reflection strip 116b converts the bulk acoustic waves into surface acoustic waves and diverts the surface acoustic waves across a surface of the substrate 113 along a Y-direction. The surface acoustic waves arrive at the first reflection strip 116a and are converted into bulk acoustic waves again by the first reflection strip 116a. The converted bulk acoustic waves transmit along the X-direction and arrive at the receiving transducer 115b. The receiving transducer 115b receives the converted bulk acoustic waves, and also sends corresponding arrival times signals of the converted bulk acoustic waves to the main processor 12. The arrival time signals superimpose to form an arrival time wave. Because a speed of sound in the substrate 113 is constant, the sound arrival time identifies its path. For example, shown in FIG. 2, a sound having a shortest path “L1” arrives at the receiving transducer 115b first, and a sound having a longest path “L2” arrives at the receiving transducer 115b last. Therefore, the main processor 12 can calculate different X-coordinates where the sounds travel according to different arrival times. Similarly, the sending transducer 114a sends bulk acoustic waves and the receiving transducer 115a receives converted bulk acoustic waves. The main processor 12 calculates Y-coordinates of the sounds.

When no object touches the substrate 113, the arrival time wave of the sounds received by the receiving transducers 115a, 115b are uninterrupted. However, when an object (for example, a finger or a stylus) touches a point “P” of the substrate 113, the sounds traveling passing the point “P” along X-direction or Y-direction are absorbed by the object and do not arrive the receiving transducers 115b, 115a. A waveform of the arrival time wave has a dip. The main processor 12 calculates X-coordinate and Y-coordinate of the point “P” according to the dip. The main processor 12 calculates out which point of the substrate 113 is touched. The main processor 12 also calculates out how long and how often the substrate 113 is touched. A firmer touch causes a greater dip, providing acoustic systems with another measurement axis perpendicular to the X and Y directions: pressure.

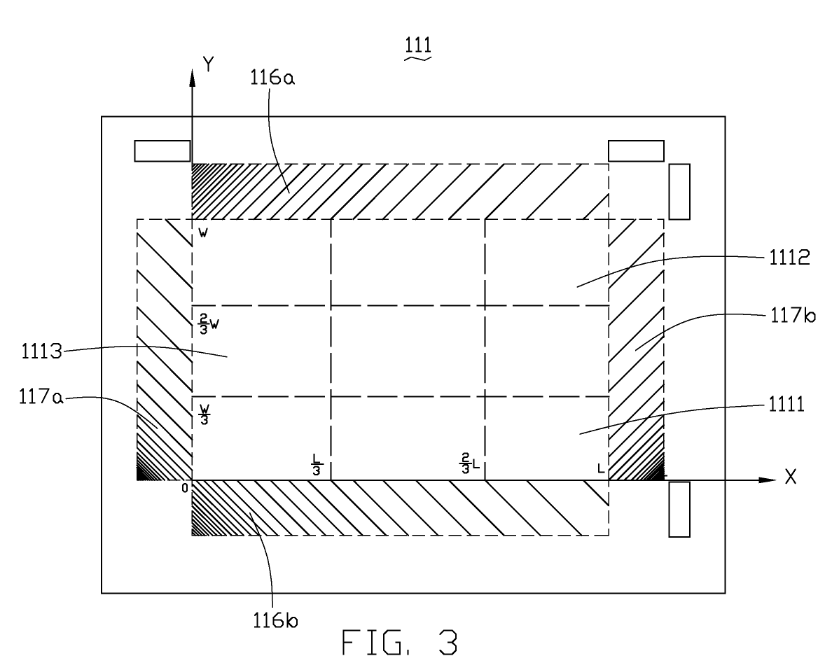

Referring to FIG. 3, the touch screen 111 of the electronic device 10, controlled by the main processor 12, is divided into several areas including areas 1111, 1112, and 1113. The touch screen 111 with a length of “L” in the X-axis direction and a width of “W” in the Y-axis direction is divided into nine areas, each of the nine areas having a width of “L/3” in the X-axis direction and a length of “W/3” in the Y-axis direction. Alternatively, the touch screen 111 can also be divided into any number of areas such as four or more than four areas. For each area, the area is regarded as touched when any point in the area is touched.

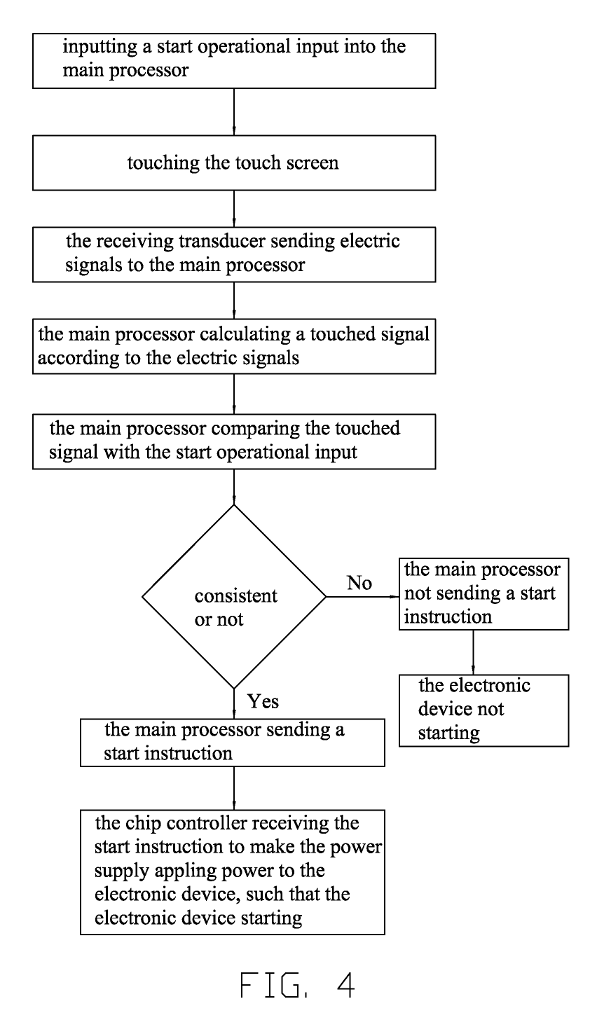

Referring to FIGS. 1-4, a method for starting the electronic device 10 is provided as below:
(1) A start operational input including a predetermined touched area, a predetermined touched duration, and a predetermined number of touched times is inputted into the main processor 12;
(2) An object such as a finger touches the touch screen 111;
(3) As described above, the receiving transducers 115a, 115b send signals to the main processor 12;
(4) The main processor 12 calculates a touched signal including a touched area, a touched duration and a number of touched times; and
(5) The main processor 12 compares the touched signal with the start operational input. If the touched signal is the same as the start operational input, the main processor 12 generates and sends a start instruction to the chip controller 131 of the circuit board 13 to make the power supply 14 applying power to the touch screen 111. Then the electronic device 10 starts. If the touched signal is different from the start operational input, the electronic device 10 does not start. The main processor 12 can calculate a touched pressure acted on the touch screen 111 either. Therefore, the start operational input may further include a predetermined touched pressure.

Referring to FIG. 3, for example, the start operational input includes: simultaneously touching areas 1111, 1112 for at least five seconds three times. Only when areas 1111, 1112 are simultaneously touched for at least five seconds three times, the main processor 12 sends the start instruction and the electronic device 10 starts. If areas 1111, 1113 are simultaneously touched for at least five seconds, the main processor 12 calculates touched signal and compares the touched signal with the start operational input. The main processor 12 does not send any start instruction for starting the electronic device 10 because the touched area of the touched signal is not consistent with the predetermined touched area of the start operational input. If areas 1111, 1112 are simultaneously touched for three seconds three times, the main processor 12 does not send any start instruction for starting the electronic device 10 because the touched duration of the touched signal is not consistent with the predetermined touched duration of the start operational input. If areas 1111, 1112 are simultaneously touched for at least five seconds twice, the main processor 12 does not send any start instruction for starting the electronic device 10 because the number of touched times of the touched signal is not consistent with the predetermined number of touched times of the start operational input.

The electronic device can also be started or unlocked by using one or two of the three predetermined touch values. In other words, the start operational input signal may be activated using one or two of the touch values instead of all three. For example, the start operational input includes the predetermined touched area, only. With this condition, no matter how long and how many times the touch screen 111 is touched as long as the touched position is consistent with the touched area of the start operational input, the main processor 12 sends the start instruction for starting the electronic device 10. Thus, only one start operational input is needed to turn on or unlock the electronic device 10. With this condition, the main processor 12 always compares the touched signal with the start operational input to turn on or unlock the electronic device 10. In another example, the start operational input includes two touch values, a predetermined touched area and a predetermined touched duration. With this condition, no matter how many times the touch screen 111 is touched as long as the touched position and the touched duration are consistent with the touched area and the touched duration of the start operational input, the main processor 12 sends the start instruction for starting the electronic device 10. Thus, only two values, of the start operational input, are needed to turn on or unlock the electronic device 10.

Additionally, a start operational input may be used for turning on the electronic device and a different start operational input may be used for unlocking the electronic device. With this condition, the main processor 12 compares the touched signal with one of the start operational inputs regarded as the turning on signal to turn on the electronic device 10 and compares another touched signal with the other start operational input regarded as the unlocking signal to unlock the electronic device 10.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device comprising:
a display having a surface acoustic touch screen, the touch screen comprising a substrate, two transmitting transducers, two receiving transducers, two first reflection strips respectively facing one of the transmitting transducers and one of the receiving transducers, and two second reflection strips respectively facing the other sending transducer and the other receiving transducer, the transmitting transducers and the receiving transducers being disposed on the substrate;
a chip controller;
a power supply electrically connected to and controlled by the chip controller; and
a main processor electrically connected to the transmitting transducers, the receiving transducers, and the chip controller, the main processor being used to contain a start operational input including at least one of a predetermined touched area, a predetermined touched duration, a predetermined touched number of touched times and a predetermined touched pressure and calculate a touched signal including at least one of a touched position, touched duration, a number of touched times and touched pressure that the touch screen touched according to signals sent from the receiving transducers, the main processor being used to further compare the touched signal with the start operational input to decide whether to send a start instruction to the chip controller to start the electronic device.

2. The electronic device as claimed in claim 1, wherein the substrate is a rectangular sheet, the first reflection strips are mounted at two opposite edges of the substrate, and the second strips are mounted at the other two edges of the substrate, the transmitting transducers are respectively mounted in two diagonal corners of the substrate, the receiving transducers are mounted in one of two other corners of the substrate.

3. The electronic device as claimed in claim 1, wherein the display further comprises a frame confining the touch screen.

4. The electronic device as claimed in claim 1, wherein the touch screen comprises several areas defined by the main processor.

5. The electronic device as claimed in claim 1 further comprising a circuit board, the main processor and the chip controller are electrically connected to the circuit board.

6. The electronic device as claimed in claim 1 further comprising a circuit board, the chip controller is electrically connected to the circuit board, and the main processor is positioned inside the display.

7. A method for starting an electronic device comprising:
providing an electronic device comprising a display, a chip controller, a power supply and a main processor, the power supply electrically connected to and controlled by the chip controller, the main processor electrically connected to the transmitting transducers, the receiving transducers, and the chip controller, the display having a surface acoustic touch screen, the touch screen comprising a substrate, two transmitting transducers, two receiving transducers, two first reflection strips respectively facing one of the transmitting transducers and one of the receiving transducers, and two second reflection strips respectively facing the other sending transducer and the other receiving transducer, the transmitting transducers and the receiving transducers being disposed on the substrate; inputting a start operational input including at least one of a touched position, touched duration, a number of touched times and touched pressure into the main processor;
touching the touch screen;
the main processor receiving signal;
the main processor receiving signals from the receiving transducers and educing a touched signal according to said signals, and the main processor comparing the touched signal with the start operational input;
the main processor sending a start instruction to the chip controller and the chip controller making the power supply applying power to the touch screen such that the electronic device starting when the touched signal being consistent with the start operational input.
